(19) United States
(12) Patent Application Publication
(10) Pub. No.: US 2010/0180589 A1
(43) Pub. Date: Jul. 22, 2010

(54) CHARGING DEVICE FOR A COMBUSTION ENGINE

(76) Inventors: Thomas Berger, Ditzingen (DE); Christoph Butscher, Leonberg (DE); Jörg Jennes, Beckenheim (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/690,459

(22) Filed: Jan. 20, 2010

(30) Foreign Application Priority Data
Jan. 21, 2009 (DE) 102009005386.7

(51) Int. Cl. F02B 33/44; F04D 29/10

(52) U.S. Cl. 60/598; 415/230

(57) ABSTRACT

The present invention relates to a charging device (1) for a combustion engine, more preferably exhaust gas turbocharger, preferentially in a motor vehicle, comprising a rotor having a compressor wheel (4) and a shaft (5), a stator (3) having a bearing housing (6) in which the shaft (5) is rotatably mounted about an axis of rotation (7) and a compressor-sided sealing zone (8), in which a rotor-sided sealing surface (9) and a stator-sided sealing surface (10) are located axially opposite each other.

An improved sealing effect can be achieved if at least one of the sealing surfaces (9, 10) has a plurality of depressions (15) arranged distributed in circumferential direction.

The present invention relates to a charging device for a combustion engine, more preferably an exhaust gas turbocharger, preferentially in a motor vehicle, with the features of the preamble of claim 1.

From WO 2008/042698 A1 an exhaust gas turbocharger is known wherein a rotor comprises a compressor wheel, a turbine wheel and a shaft. A stator comprises a bearing housing in which the shaft of the rotor is rotatably mounted about an axis of rotation. Furthermore, a rotor-sided sealing surface and a stator-sided sealing surface are located axially opposite each other in a compressor-sided sealing zone. With the known turbocharger the sealing surfaces are configured so that the rotor-sided sealing surface axially overlaps the stator-sided sealing surface.

Through compressor-sided sealing between rotor and stator it is attempted to prevent or to reduce the entry of compressed air in a lubricating oil circuit or the transfer of lubricating oil in the fresh air tract. Rising requirements in terms of pollutant emissions and economy lead to an increased need for effective seals. At the same time, the requirement in terms of space and manufacturing costs for this is to be small and low respectively.

The present invention deals with the problem of stating an improved embodiment for a charging device of the type mentioned at the outset which is more preferably characterized by a space-saving design with effective sealing.

According to the invention this problem is solved through the subject of the independent claim. Advantageous embodiments are the subject of the dependent claims.

The invention is based on the general idea of providing at least one of the sealing surfaces with a plurality of depressions or clearances which in circumferential direction are arranged adjacent to one another. Axially, the depressions are open towards each of the opposite sealing surfaces and contain a gas volume. With the charging device in operation, the rotation of the rotor based on centrifugal forces results in that within these depressions, gas is driven radially to the outside. Because of this, a gas cushion with increased pressure or a gas flow orientated radially to the outside can form in the sealing zone, depending on the configuration of the depressions. The gas flow or the gas cushion results in intensive sealing or media separation. Both the gas cushion as well as the gas flow prevent a transfer of lubricating oil to the fresh air side. The formation of a gas cushion can also contribute towards obstructing or preventing a transfer of air in the direction of the lubricating oil circuit.

In addition to the improved sealing effect the proposed design is also characterized in that its construction is extremely compact in axial direction. More preferably the depressions can be formed on sealing surfaces which are present anyhow so that for realising the depressions no additional space is required. At the same time, only reduced additional manufacturing costs will be incurred for realising the proposed design.

According to an advantageous embodiment the depressions can each have an inner cross-sectional area radially on the inside and an outer cross-sectional area radially on the outside wherein the inner cross-sectional area and the outer cross-sectional area are different in size. For example it is possible to configure the outer cross-sectional area smaller than the inner cross-sectional area. Through the rotation, the gas driven towards the outside cannot flow off rapidly enough so that the pressure between the sealing surfaces is increased, as a result of which the air cushion effect can be significantly increased. Alternatively, the outer cross-sectional area can also be selected larger than the inner cross-sectional area so that it is possible to reduce the pressure gradient.

With an advantageous embodiment it can be provided that the depressions are configured so that in their radial course each comprise a longitudinal centre line which extends inclined in circumferential direction with respect to the radial direction with regard to the axis of rotation. The respective longitudinal centre line can be straight or curved. This results in crescent-shaped depressions. With such configurations the pressure conditions in the sealing zone can be further matched to the respective requirements. Depending on the orientation of the inclined depressions, either clockwise or anti-clockwise, the radial delivery effect for the gas volume within the depressions can be reduced or increased.

Additional important features and advantages of the invention are obtained from the subclaims, from the drawings and from the corresponding figure description by means of the drawings.

It is to be understood that the features mentioned above and still to be explained in the following cannot only be used in the respective combination stated but also in other combinations or by themselves, without leaving the scope of the present invention.

Preferred exemplary embodiments of the invention are shown in the drawings and are explained in more detail in the following description, wherein same reference characters refer to same or similar or functionally same components. It shows, in each case schematically,

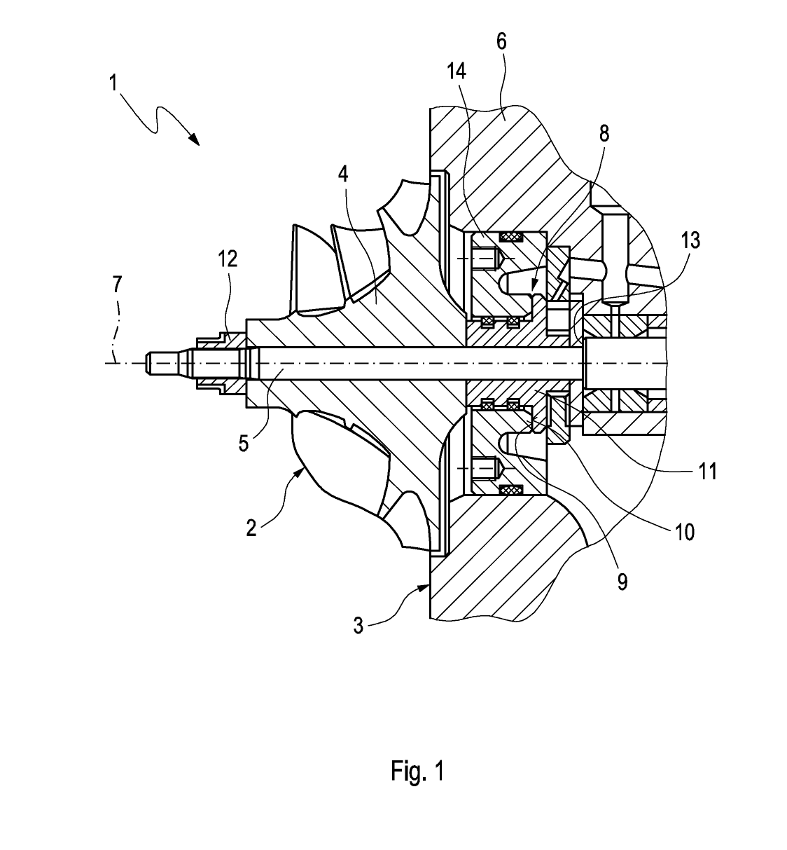

FIG. 1 a greatly simplified longitudinal section of a charging device in the region of a compressor side,

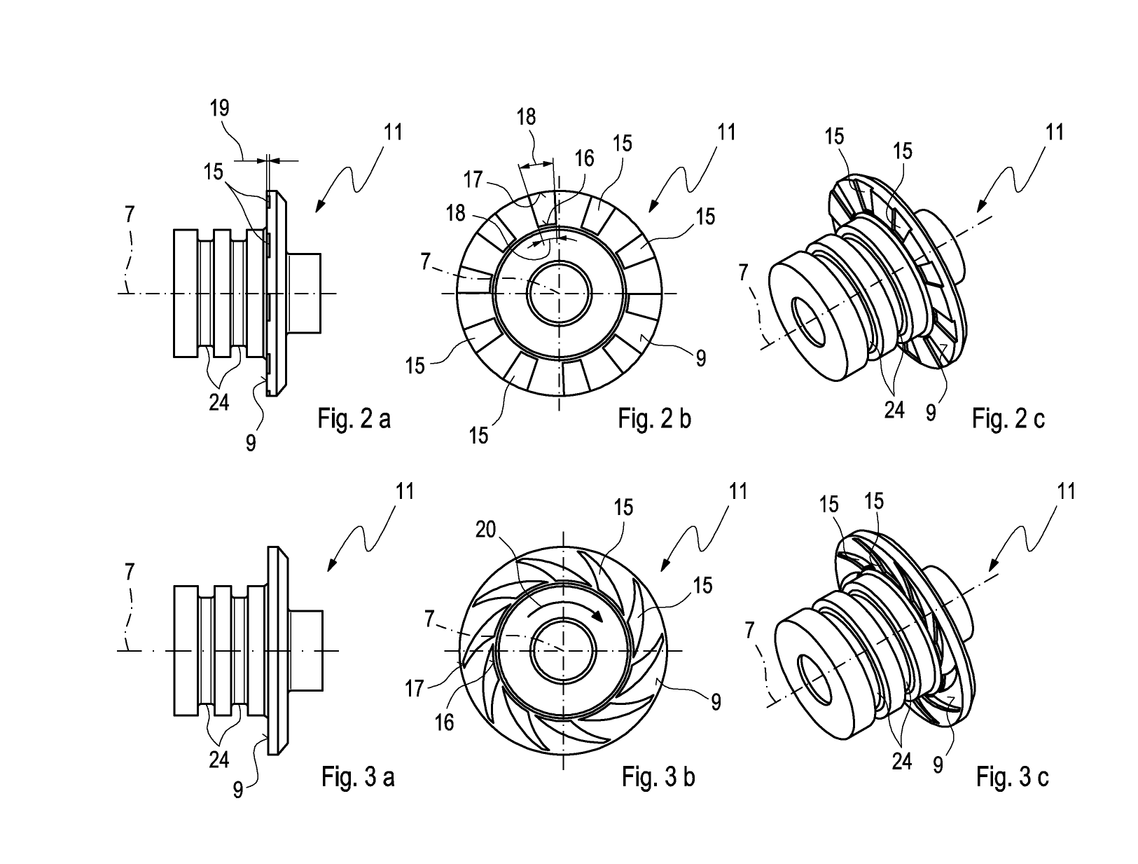

FIG. 2 a lateral view (a), an axial view (b) and a perspective view (c) of a sealing bush with a first embodiment,

FIGS. 3 to 5 views as in FIG. 2, however with further embodiments,

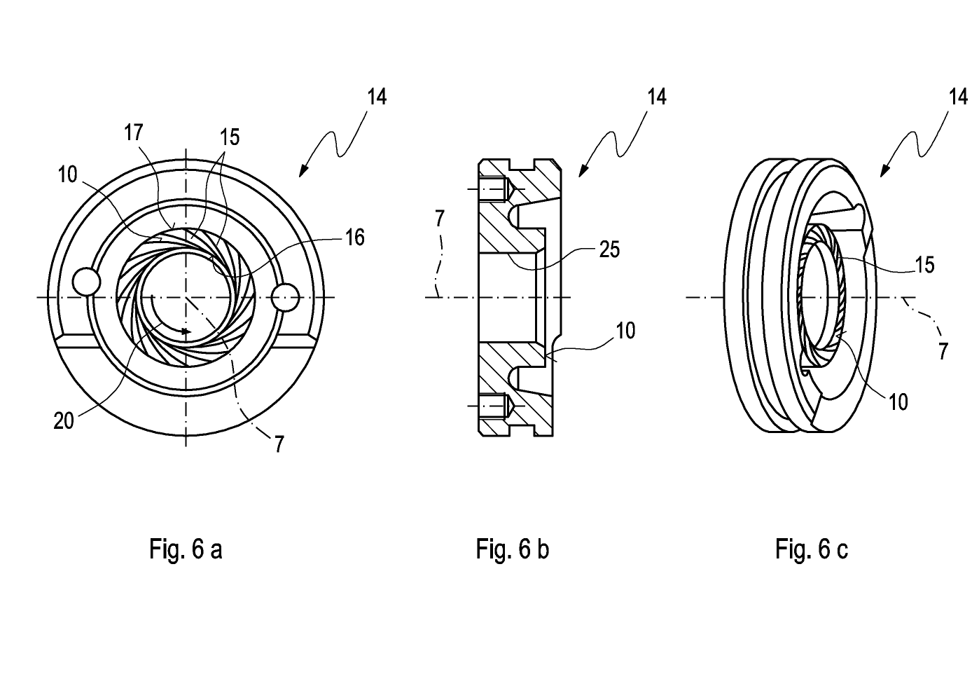

FIG. 6 an axial view (a), an axial section (b) and a perspective view (c) of a bearing cap,

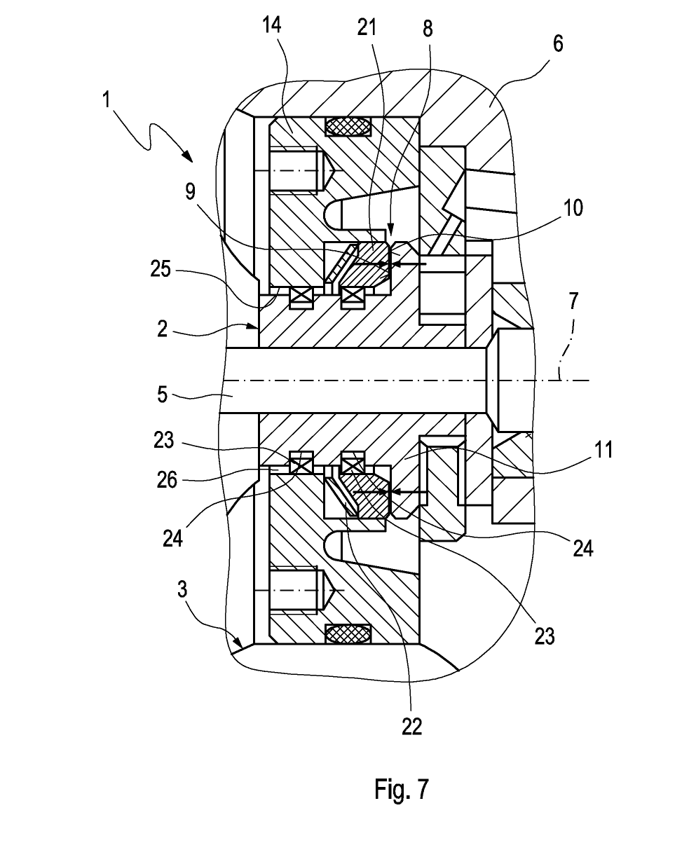

FIG. 7 an axial section as in FIG. 1 in the region of a bearing cap, however with another embodiment.

According to FIG. 1, a charging device 1 (FIG. 1), which preferably is an exhaust gas turbocharger which can be used in a motor vehicle for charging a combustion engine, comprises a rotor 2 and a stator 3. The rotor 2 in the usual manner comprises a compressor wheel 4 a shaft 5 connected with the compressor wheel 4 in a rotationally fixed manner and a turbine wheel which is not shown here, which is likewise connected with the shaft 5 in a rotationally fixed manner. The stator 3 comprises a bearing housing 6 in which the rotor 2 and the shaft 5 respectively are rotatably mounted about an axis of rotation 7. Usually the stator 3 additionally comprises a compressor housing which is not shown, in which the compressor wheel 4 is arranged, and a turbine housing which is likewise not shown here, in which the turbine wheel is arranged. FIG. 1 shows the compressor side of the charging device 1, i.e. the region adjoining the compressor wheel 4. Also in this region is located a compressor-sided sealing zone 8, which between the rotor 2 and the stator 3 realises a seal in order to prevent a transfer of lubricating oil into the fresh air path. In this sealing zone 8 a rotor-sided sealing surface 9 and a stator-sided sealing surface 10 are located axially opposite each other. In the shown, preferred example the two sealing surfaces 9, 10 each are located in a plane which extends perpendicularly to the axis of rotation 7. In principle, conical or curved sealing surfaces are also conceivable however.

The rotor-sided sealing surface 9 in the preferred example is formed on a sealing bush 11 which is attached to the shaft 5 such that it co-rotates with the shaft 5. To this end, the sealing bush 11 for example can be clamped together with the compressor wheel 4 against a collar 13 of the shaft 5 through a screw connection 12. In the example, the stator-sided sealing surface 10 is formed on a bearing cap 14. The bearing cap 14 closes the bearing housing 6 on the compressor side, that is on an axial side facing the compressor wheel 4.

According to FIGS. 2 to 6 at least one of the sealing surfaces 9, 10 is to be provided with a plurality of depressions 15 which, with respect to the axis of rotation 7, are arranged distributed in circumferential direction. In addition, these are arranged spaced from one another in circumferential direction along the respective sealing surface 9, 10. Here, the depressions 15 are formed in form of pockets or clearances which are worked into the plane of the respective sealing surface 9, 10.

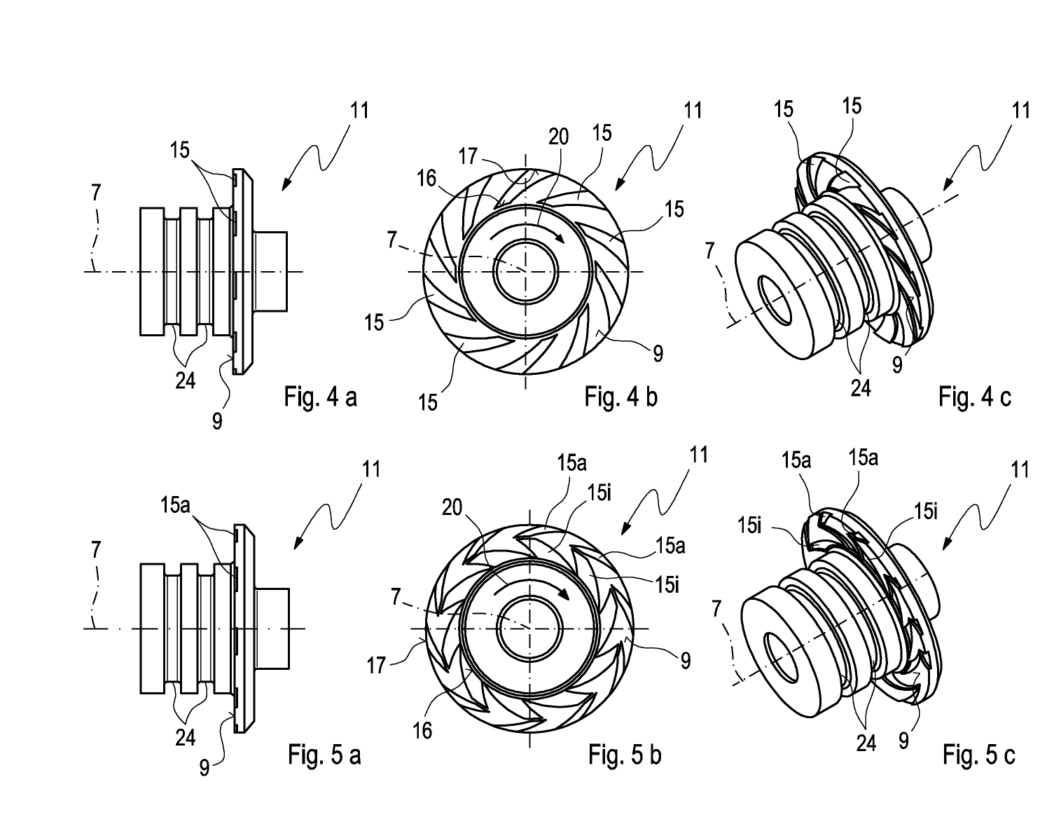

The depressions 15 each comprise an inner cross-sectional area 16 radially inside and an outer cross-sectional area radially outside. The respective cross-sectional area 16, 17 is calculated from a length 18 with which the respective depression 15 extends in circumferential direction and from a depth 19, with which the respective depression 15 extends in axial direction. The length 18 can have a different value radially inside than radially outside. Likewise the depth 19 can have a different value radially inside than radially outside. Furthermore, more preferably the depth 19 can be constant in radial direction. Noticeably the depth 19 of the depressions relative to the length 18 is small so that the depressions 15 are shallow. Furthermore, they are axially closed on one side, i.e. not continuous. Preferably the cross-sectional areas 16, 17 of the depressions 15 are configured different in size. For example the inner cross-sectional area 16 with the embodiments of FIGS. 2 and 4 is smaller than the outer cross-sectional area 17. In contrast with this in the embodiment shown in FIG. 3 the inner cross-sectional area 16 is larger than the outer cross-sectional area 17.

With the embodiment shown in FIG. 2, the depressions 15 are so configured that in their radial course they each have a longitudinal centre line which is not drawn in here which with respect to the axis of rotation 7 extends radially, that is exclusively radially. Furthermore, with the embodiment of FIG. 2, the longitudinal centre lines of the depressions 15 are each embodied in a straight line. Such an embodiment is independent of the respective direction of rotation or of the rotor 2.

In contrast with this, FIG. 3 to 6 show embodiments wherein the depressions 15 in their radial course each comprise a longitudinal centre line which with respect to the radial direction extends inclined in circumferential direction. In FIGS. 3b, 4b, 5b and 6a, the direction of rotation 20, with which the rotor 2 in operation of the charging device 1 rotates relative to the stator 3, is indicated by an arrow. It is noticeable with the embodiment shown in FIG. 3 that the inclination of the depressions 15 with respect to the direction of rotation 20 is so orientated that the depressions 15 trail radially to the outside. The depressions 15 are thus inclined radially from the inside to the outside against the direction of rotation 20. In contrast with this, FIGS. 4 and 6 show embodiments wherein the depressions 15 trail radially to the inside with respect to the direction of rotation 20. This means the depressions 15 are inclined with the direction of rotation 20 from radially inside to outside.

The depressions 15 or their longitudinal centre lines which are inclined in the circumferential direction are curved in the examples as a result of which a crescent-shaped figure for the individual depressions 15 is created. In principle however, straight longitudinal centre lines or depressions 15 are also conceivable here.

With the embodiments of FIGS. 2, 4 and 6 the depressions 15 are so embodied that they end radially outside the sealing zone 8 or are radially open as in the examples. Thus gas, which through the rotation of the rotor 2 is accelerated radially to the outside, can be discharged from the depressions 15 particularly easily. With these radially open depressions 15 the outer cross-sectional area 17 in each case is configured larger than the corresponding inner cross-sectional area 16, as a result of which the pressure gradient is reduced radially from the inside to the outside. In contrast with this, FIG. 3 shows an embodiment wherein the depressions 15 end radially on the outside within the sealing zone 8, i.e. do not extend as far as to the end of the respective sealing surface 9 or 10 located radially on the outside. With such an embodiment the formation of a gas cushion within the sealing zone 8 is supported. On the other hand, the formation of a gas flow orientated to the outside is supported with the depressions 15 open radially outside. With the embodiment shown in Fig. the inner cross-sectional area 16 is additionally selected larger than the outer cross-sectional area 17, as a result of which the pressure increase is intensified radially outside in order to support the formation of the gas cushion.

FIG. 5 shows an embodiment wherein in radial direction inner depressions 15i and outer depressions 15a are arranged adjacent to each other within the same sealing surface 9. Here, the inner depressions 15i and the outer depressions 15a do not directly merge but are separated from each other through a web-shaped remainder of the respective sealing surface 9. Thus the inner depressions 15i end within the sealing zone 8. In the example, the outer depressions 15a are open radially outside. In addition, the inner and outer depressions 15i, 15a in the example have different inclinations relative to the direction of rotation 20. For example the inner depressions 15i are orientated so that they trail radially outside while the outer depressions 15a are orientated so that they trail radially inside. Through the proposed configuration of the depressions 15 and 15i and 15a respectively the pressure distribution within the sealing zone 8 can be specifically dimensioned or designed so that a desired sealing effect is obtained.

While FIG. 2 to 5 show exemplary embodiments for forming such depressions 15 on the rotor-sided sealing surface 9, FIG. 6 shows an embodiment wherein such depressions 15 can likewise be formed on the stator-sided sealing surface 10. Here, a configuration is shown for example as is also evident with the embodiment shown in FIG. 4. It is clear that in principle the other configurations on the rotor side can also be realised on the stator side. Here, the depressions 15 can either be formed exclusively on the stator-sided sealing surface 10 or exclusively on the rotor-sided sealing surface 9 or both on the stator-sided sealing surface 10 as well as on the rotor-sided sealing surface 9. Insofar as both sealing surfaces 9, 10 have inclined depressions 15, these can be inclined in clockwise direction or in anti-clockwise direction.

FIG. 7 shows a particular embodiment wherein the charging device 1 in the region of the sealing zone 8 comprises a sealing surface carrier 21 which is coupled with the stator 3 with the help of a spring device 22 and axially driven against the rotor 2. Here, the stator-sided sealing surface 10 is formed on the sealing surface carrier 21, wherein the sealing surface carrier 21 is driven with the help of the spring device 22 in such a manner that the stator-sided sealing surface 10 formed thereon is axially driven in the direction of the rotor-sided sealing surface 9. In the shown example the sealing surface carrier 21 is axially supported on the bearing cap 14 via the spring device 22. Furthermore, the sealing surface carrier 21 is attached axially adjustable on the bearing cap 14. Optionally it can be arranged on the bearing cap 14 in a rotationally fixed manner. Through the axial preload with which the two sealing surfaces 9, 10 are axially loaded on to each other, the pressure in the gap between the sealing surfaces 9, 10 can be increased, or limited to a predetermined value, which improves the sealing effect. The axial adjustability can be limited for example by means of a stop which is not shown here. Because of this, a minimal axial sealing play can be guaranteed between the two sealing surfaces 9, 10.

In the shown example, two shaft sealing rings 23 are additionally provided for sealing between rotor 2 and stator 3. These are arranged for example between the bearing bush 11 and the bearing cap 14. For example the bearing bush 11 comprises suitable retaining slots 24 for this purpose in which the respective shaft sealing ring 23 is inserted. The shaft sealing rings 23 abut a cylindrical inner wall 25 of the bearing cap 14 radially on the outside and bridge or seal a cylindrical ring gap 26 formed radially between the sealing bush 11 and the bearing cap 14 as a result. The depressions 15 of the stator-sided sealing surface 10 and/or the rotor-sided sealing surface 9 are arranged or configured so that they communicate with this ring gap 26. For example the respective depressions 15 to this end are open towards the ring gap 26 radially inside or extend as far as into the ring gap 26.

1. An exhaust gas charging device comprising:
a rotor configured to receive a compressor wheel and a shaft;
a stator having a bearing house, in which the shaft is rotatably mounted about an axis of rotation, with a compressor-sided sealing zone, wherein a rotor-sided sealing surface and a stator-sided sealing surface are configured axially opposite each other, such that at least one of the sealing surfaces is configured to have a plurality of depressions arranged in a circumferential direction.

2. The charging device according to claim 1, wherein the rotor-sided sealing surface is formed on a sealing bush attached to the shaft.

3. The charging device according to claim 1, wherein the stator-sided sealing surface is formed on a bearing cap, which closes the bearing housing on the compressor side.

4. The charging device according to claim 1, wherein the depressions each comprise an inner cross-sectional surface radially inside and an outer cross-sectional surface radially outside, wherein the inner cross-sectional area and the outer cross-sectional area are different in size.

5. The charging device according to claim 1, wherein the depressions each have a longitudinal centre line, which with respect to the axis of rotation extends radially and in a straight line.

6. The charging device according to claim 1, wherein the depressions each comprise a longitudinal centre line, which with respect to a radial direction extend inclined in the circumferential direction.

7. The charging device according to claim 1, wherein the depressions end radially outside within the sealing zone.

8. The charging device according to claim 4, wherein each of the depressions inner cross-sectional area is larger than the outer cross-sectional area.

9. The charging device according to claim 7, wherein the depressions with respect to the direction of rotation of the rotor are so inclined that they trail radially outside.

10. The charging device according to claim 1, wherein the depressions end in at least one of radially outside the sealing zone and are radially open.

11. The charging device according to claim 4, wherein each of the depressions outer cross-sectional areas is larger than the inner cross-sectional areas.

12. The charging device according to claim 10, wherein the depressions are so inclined that they trail radially inside with respect to the direction of rotation of the rotor.

13. The charging device according to claim 1, wherein in a radial direction inner depressions and outer depressions are arranged adjacent on the same sealing surface.

14. The charging device according to claim 1, wherein both sealing surfaces are provided with depressions.

15. The charging device according to claim 13, wherein at least one of the inner and outer depressions and the stator-sided and rotor-sided depressions are opposingly inclined with respect to the direction of rotation of the rotor.

16. The charging device according to claim 1, wherein the stator-sided sealing surface is formed on a sealing surface carrier which by means of a spring device is axially driven in a direction of the rotor-sided sealing surface.

17. The charging device according to claim 16, wherein the sealing surface carrier is axially supported on the bearing cap via the spring device.

18. The charging device according to claim 1, wherein the stator-sided sealing surface is formed on a bearing cap, which closes the bearing housing on the compressor side.

19. The charging device according to claim 6, wherein the depressions with respect to the direction of rotation of the rotor are so inclined that they trail radially outside.

20. The charging device according to claim 6, wherein the depressions are so inclined that they trail radially inside with respect to the direction of rotation of the rotor.
